(19) United States
(12) Patent Application Publication
(10) Pub. No.: US 2007/0071450 A1
(43) Pub. Date: Mar. 29, 2007

(54) Systems and methods for optical power window control

(75) Inventors: Paul Schatz, Burnsville, MN (US); Dean Zavadsky, Shakopee, MN (US); William J. Mitchell, Eden Prairie, MN (US); Thomas Wall, Mankato, MN (US); Steve Stuart, Eden Prairie, MN (US)

Correspondence Address: Laura A. Ryan, Suite 1000, 10 South Fifth Street, Minneapolis, MN, 55402, US

(73) Assignee: ADC Telecommunications, Inc., Eden Prairie, MN (US)

(21) Appl. No.: 11/238,364

(22) Filed: Sep. 29, 2005

(51) Int. Cl. H04B 10/00

(52) U.S. Cl. 398/162

(57) ABSTRACT

Methods and systems for controlling optical power levels in an optical communications network are provided. In one embodiment, a system comprises means for demodulating one or more radio frequency communications signals from a modulated optical signal, wherein the means for demodulating measures an optical power level of the modulated optical signal; means for comparing the measured optical power level to one or more reference set points; means for transmitting a feedback signal, wherein the feedback signal is based on the difference between the measured optical power level and the one or more reference set points; and means for attenuating the modulated optical signal based on the feedback signal.

### CROSS REFERENCES TO RELATED APPLICATIONS

This application is related to the following co-pending United States patent applications filed on even date herewith, all of which are hereby incorporated herein by reference:

United States patent application serial number ______ (attorney docket number 100.724US01 entitled “Methods and Systems for Controlling Optical Power Attenuation”) and which is referred to here as the '724 Application.

### TECHNICAL FIELD

The present invention generally relates to voice and data communications networks and more specifically to optical power feedback based attenuation in optical communications networks.

### BACKGROUND

One of the major challenges of installing and operating optical data communications systems, such as those often used to communicate data within cellular networks, is maintaining optical power levels within the power windows required for optical receivers to correctly function.

One way the communications industry has handled this requirement is by installing fixed inline optical power attenuators in the physical layer of an optical communications system. However, problems arise in this solution because every network facility is different in terms of optical power loss due to equipment and varying fiber optic cable lengths. To implement the fixed optical power attenuator solution, network operators must deploy technicians to manually take optical power measurements at one location while calibrating attenuators at other locations. Besides the high implementation and operational expenses associated with fixed inline attenuators, their presence in the physical layer of a communications network create additional points for introducing contamination and network failures.

For the reasons stated above and for other reasons stated below which will become apparent to those skilled in the art upon reading and understanding the specification, there is a need in the art for improved methods and systems for optical power window control.

### SUMMARY

The Embodiments of the present invention provide methods and systems for optical power window control and will be understood by reading and studying the following specification.

In one embodiment, ah optical communication network is provided. The network comprises a transmitter coupled to a first communications network segment, the transmitter adapted to modulate an optical light signal based on one or more first radio frequency communication signals received from the first communications network and launch the modulated optical light signal; a receiver coupled to a second communications network, the receiver adapted to receive the modular optical light signal, demodulate the modulated optical light signal into one or more second radio frequency communications signals, and output the one or more second radio frequency communications signals to the second communications network; and at least one optical power attenuator that dynamically adjusts the attenuation of the modulated optical light signal based on one or more of an optical power level of the received modulated optical light signal and an optical power level of the launched modulated optical light signal.

In another embodiment, a method for controlling optical power in an optical communications network is provided. The method comprises modulating optical signals with one or more radio frequency communication signals received from a first communications network segment; launching the modulated optical signal on one or more optical media; receiving the modulated optical signal at an optical receiver; measuring optical power of one or more of a received optical power level of the modulated optical light and a launched optical power level of the modulated optical light signal; generating an attenuation control signal based on the measured optical power; and attenuating the modulated optical signal based on the attenuation control signal.

In yet another embodiment, a computer-readable medium having computer-executable program instructions for a method for managing optical power levels in an optical communications network, the method comprising comparing a measured optical power level of an optical signal to one or more reference set points; and transmitting a feedback signal based on the difference between the measured optical power level and the one or more reference set points.

In still another embodiment, a system for controlling optical power levels in a communications network. The system comprises means for demodulating one or more radio frequency communications signals from an modulated optical signal, wherein the means for demodulating measures an optical power level of the modulated optical signal; means for comparing the measured optical power level to one or more reference set points; means for transmitting a feedback signal based on the difference between the measured optical power level and the one or more reference set points; and means for attenuating the modulated optical signal based on the feedback signal.

### DRAWINGS

The present invention can be more easily understood and further advantages and uses thereof more readily apparent, when considered in view of the description of the preferred embodiments and the following figures in which:

FIG. 1 is a diagram illustrating a communications network having received optical power feedback based attenuation of one embodiment of the present invention.

FIG. 2 is a diagram illustrating a communications network having launched optical power feedback based attenuation of one embodiment of the present invention.

FIG. 3 is a diagram illustrating a communications network having bi-directional optical power feedback based attenuation of one embodiment of the present invention.

FIGS. 4A and 4B are flowcharts illustrating a method for optical power feedback based attenuation of one embodiment of the present invention.

FIGS. 5A and 5B are flowcharts illustrating a method for optical power feedback based attenuation of one embodiment of the present invention.

In accordance with common practice, the various described features are not drawn to scale but are drawn to emphasize features relevant to the present invention. Reference characters denote like elements throughout figures and text.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. The following detailed description is, therefore, not to be taken in a limiting sense.

Embodiments of the present invention address maintaining optical power levels in communications networks within the required power windows for optical receivers through a feedback controlled optical power attenuation system. Embodiments of the present invention provide automated set-up and control of optical power in communications network thus reducing installation and long term operating expenses for network operators. Embodiments of the present invention eliminate the need to send technicians to remote locations to perform inline attenuator calibrations. Additionally, embodiments of the present invention provide enhanced effective optical signal receive power due to threshold maximization, enhanced alarming accuracy, and customization of the optical receive power window.

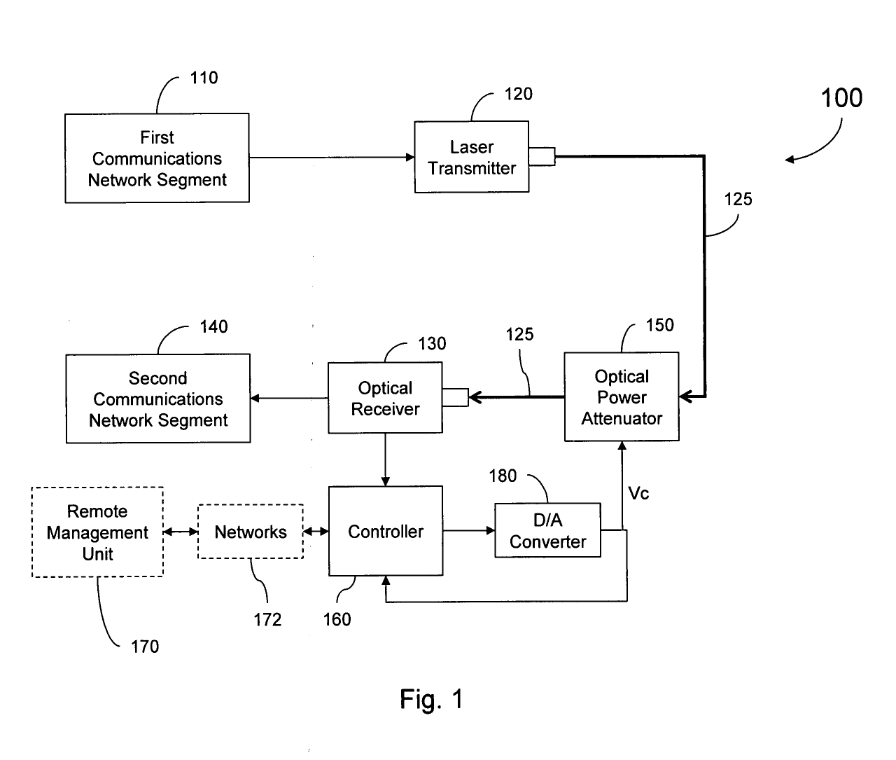

FIG. 1 illustrates a telecommunications network 100 of one embodiment of the present invention where baseband communication signals are transmitted from a first communications network segment 110 to a second communications network segment 140 via a fiber optic link. In one embodiment, first communications network segment 110 comprises a cellular remote unit that receives wireless radio frequency communications signals and modulates the signals to a baseband frequency. In one embodiment, network segment 110 further converts the signals from analog to digital. In one embodiment, second communications network segment 140 comprises a cellular remote unit that receives baseband communications signals, re-modulates the signals to a radio channel, and wirelessly transmits the signals as radio frequency communications signals. In one embodiment, second communications network segment 140 further converts the signals from digital to analog.

In one embodiment, first communications network segment 110 outputs baseband communication signals to a laser transmitter 120 that modulates laser light based on the baseband communication signals, and transmits the modulated laser light to optical receiver 130 via one or more fiber optic media 125. In one embodiment, the baseband communications signals are analog signals. In one embodiment, the baseband communications signals are digital signals. Fiber optical media 125 is one or more of single wavelength, multiple wavelength and bidirectional wavelength. Optical receiver 130 demodulates the laser light back into a baseband signal and outputs that baseband signal to second communications network segment 140. In one embodiment, the baseband signal is an analog signal. In one embodiment, the baseband signal is a digital signal. Optical receiver 130 has very specific window of operation for receiving optical signals, and too much power will damage optical receiver 130. Due to differences in manufacturer's specifications, there is no guarantee that the power of the optical signal launched by laser transmitter 120 will be within the window of operation when the signal reaches optical receiver 130.

For example, in one embodiment, laser transmitter 120 launches a modulated optical light signal having an optical power of +3 dBm while optical receiver 130 requires received optical light signals to fall within a window of operation between 0 dBm to −8 dBm. The modulated optical light signal must be attenuated at least 3 dBm to prevent damage to optical receiver 130, but attenuated no more than 11 dBm to ensure that optical receiver can reliably demodulate the signal to recover the baseband communications signals. Embodiments of the present invention allow a communications network to automatically attenuate an optical signal to prevent damage to a receiver while still maintaining adequate optical power to reliably demodulate the optical signal.

To regulate the power of the optical signals in network 100, embodiments of the present invention comprise the inclusion of a feedback system in the form of a feedback controlled optical power attenuator 150 coupled between laser transmitter 120 and optical receiver 130 and a controller 160 coupled to optical receiver 130. In one embodiment, optical receiver 130 outputs a digital signal representing the optical power level of a received optical signal. Controller 160 receives the optical power level signal, and based on the optical power level signal generates an attenuation control signal for transmission to optical power attenuator 150. In one embodiment, optical power attenuator 150 adjusts the attenuation of the optical power level of the optical signal launched by laser transmitter 120 to maintain the optical power level within a specified window of operation for optical receiver 130 based on a feedback signal.

In one embodiment, controller 160 is a programmable controller and maintains the optical power level of the signal received by optical receiver 130 within upper and lower power thresholds based on the window of operation for optical receiver 130.

In one embodiment, controller 160 maintains the optical power level of signals received by optical receiver 130 within upper and lower reference set points. When the optical power received by optical receiver 130 is greater than an upper reference set point, controller 160 will generate an attenuation control signal that causes optical power attenuator 150 to increase the attenuation of the optical signal. When the optical power received by optical receiver 130 is less than the lower reference set point, controller 160 will generate an attenuation control signal that causes optical power attenuator 150 to reduce the attenuation of the optical signal. When the optical power received by optical receiver 130 is within the upper and lower reference set points, controller 160 will generate an attenuation control signal which causes optical power attenuator 150 to maintain attenuation of the optical signal at the current attenuation level.

In one embodiment, controller 160 maintains the optical power level of the signal received by optical receiver 130 at a specific power level within the window of operation. In one embodiment, controller 160 implements different feedback transfer functions and algorithms to achieve a desired closed loop optical power level response for parameters such as time response, signal dampening, and allowable study state error.

In one embodiment, the attenuation control signal output of controller 160 is a digital signal directly coupled to optical power attenuator 150. In one embodiment, the attenuation control signal output from controller 160 is converted into an analog control signal (Vc) by D/A converter 180. In that case, optical power attenuator 150 inputs the converted analog attenuation control signal. In one embodiment, analog control signal Vc is a voltage signal. In one embodiment, controller 160 further measures Vc and adjust the digital attenuation control signal input to D/A converter 180 to ensure optical power attenuator 150 is receiving the desired feedback signal.

In one embodiment, network 100 further comprises a remote management unit 170 coupled to controller 160 through communication link 172. Remote management unit 170 provides an interface that allows an operator of network 100 to initialize and configure controller 160. In one embodiment, communication link 172 comprises a network adapted to communicate messages between remote management unit 170 and controller 160. In one embodiment, communication link 172 is a serial communications line. In one embodiment, communication link 172 is an IP based network. In one embodiment, communication link 172 is a wireless link. Remote management unit 170 allows network operators to alter reference set points or replace algorithms in controller 160, to interrogate controller 160 to review current set points and algorithms, and to observe the optical power level of optical signals received by optical receiver 130. In one embodiment, controller 160 alerts network operators of anomalies by communicating one or more alarms when optical power levels fall outside a desired operating range. In one embodiment, controller 160 communicates with management module 170 via one or more of, but not limited to, Transaction Language 1 (TL1) network management protocol, Common Management Interface Protocol (CMIP) network management protocol, and simple network management protocol (SNMP) and sending and receiving ASCII based messages through a command line interface.

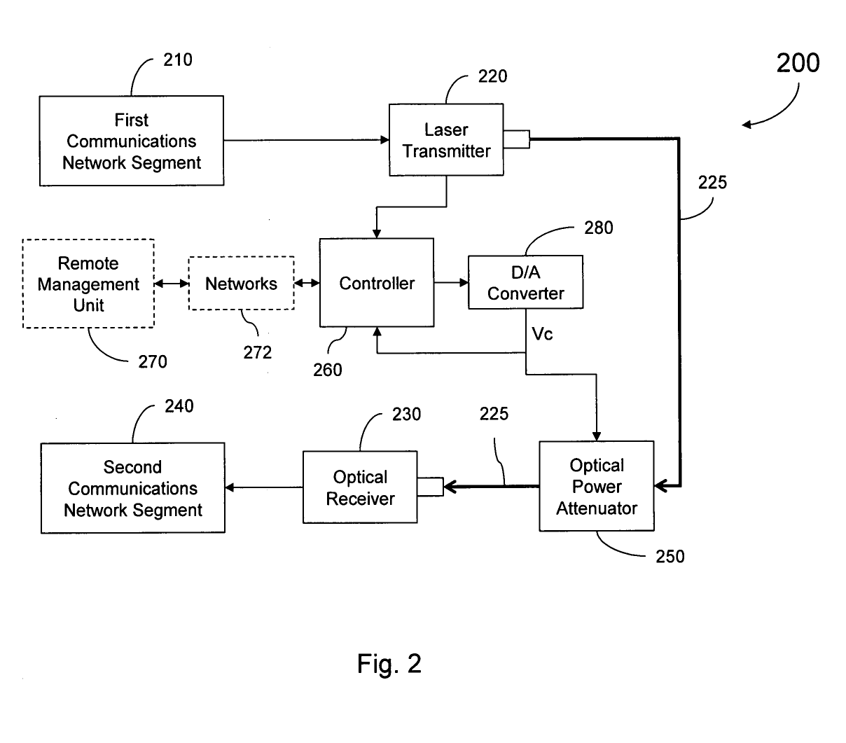

FIG. 2 illustrates another telecommunications network 200 of one embodiment of the present invention where baseband communication signals are transmitted from a first communications network segment 210 to a second communications network segment 240 via a fiber optic media 225. Fiber optical media 225 is one or more of single wavelength, multiple wavelength and bidirectional wavelength. As described with respect to FIG. 1, an optical power attenuator 250 maintains the optical power level within a window of operation for optical receiver 230 based on a feedback signal from a controller 260. Controller 260 adjusts the attenuation of the optical signals in network 200 based on optical power level feedback from laser transmitter 220.

In one embodiment, laser transmitter 220 outputs a digital signal representing the optical power level of the optical signal it launches. Controller 260 receives the optical power level signal, and based on the optical power level signal generates an attenuation control signal for transmission to optical power attenuator 250, as described with respect to FIG. 1 above. In one embodiment, optical power attenuator 250 generates an attenuation control signal to instructing optical power attenuator 250 to increase the attenuation of the optical signal when the optical power transmitted by laser transmitter 220 is too great, and decrease the attenuation of the optical signal when the optical power transmitted by laser transmitter 220 is too low. In one embodiment, when the optical power transmitted by laser transmitter 220 is within upper and lower reference set points, controller 260 generates an attenuation control signal which causes optical power attenuator 250 to maintain attenuation of the optical signal at the current attenuation level.

In one embodiment, the attenuation control signal output of controller 260 is a digital signal directly coupled to optical power attenuator 250. In one embodiment, the attenuation control signal output of controller 260 is converted into an analog control signal (Vc) by D/A converter 280. In that case, optical power attenuator 250 inputs the converted analog attenuation control signal, Vc. In one embodiment, analog control signal Vc is a voltage signal. In one embodiment, controller 260 further measures Vc and adjusts the digital attenuation control signal input to D/A converter 280 to ensure optical power attenuator 250 is receiving the desired feedback signal.

In one embodiment, network 200 further comprises a remote management unit 270 coupled to controller 260 through one or more networks 272. Remote management unit 270 provides an interface that allows an operator of network 200 to initialize and configure controller 260. In one embodiment, communication link 272 comprises a network adapted to communicate messages between remote management unit 270 and controller 260. In one embodiment, communication link 272 is a serial communications line. In one embodiment, communication link 272 is an IP based network. In one embodiment, communication link 272 is a wireless link. Remote management unit 270 allows network operators to alter reference set points or replace algorithms in controller 260, to interrogate controller 260 to review current set points and algorithms, and to observe the optical power level of optical signals. In one embodiment, controller 260 alerts network operators of anomalies by communicating one or more alarms when optical power levels fall outside a desired operating range. In one embodiment, controller 260 communicates with management module 270 via one or more of, but not limited to, Transaction Language 1 (TL1) network management protocol, Common Management Interface Protocol (CMIP) network management protocol, and simple network management protocol (SNMP) and sending and receiving ASCII based messages through a command line interface.

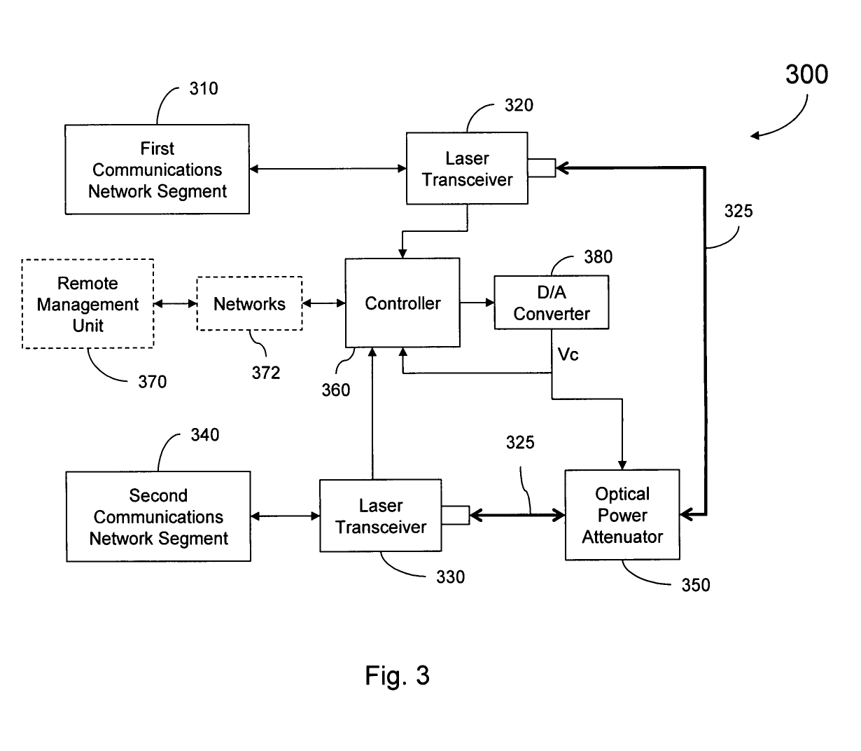

FIG. 3 illustrates a bi-directional a telecommunications network 300 of one embodiment of the present invention. In one embodiment, in the uplink direction, a first communications network segment 310 outputs baseband communication signals to an optical laser transceiver 320. In one embodiment, the baseband communications signals are analog signals. In one embodiment, the baseband communications signals are digital signals. Optical laser transceiver 320 modulates laser light based on the baseband communication signals, and transmits the modulated laser light to optical laser transceiver 330 via one or more fiber optic media 325. Fiber optical media 325 is one or more of single wavelength, multiple wavelength and bidirectional wavelength. Optical laser transceiver 330 then demodulates the laser light back into a baseband communications signal and outputs that baseband communications signal to a second communications network segment 340. In one embodiment, the baseband communications signal is an analog signal. In one embodiment, the baseband communications signal is a digital signal. Transmitting data in the downlink direction, second communications network segment 340 outputs baseband communication signals to optical laser transceiver 330. In one embodiment, the baseband communications signals are analog signals. In one embodiment, the baseband communications signals are digital signals. Optical laser transceiver 330 modulates laser light based on the baseband communication signals, and transmits the modulated laser light to optical laser transceiver 320 via one or more fiber optic media 325. Optical laser transceiver 320 demodulates the laser light back into a baseband signal and outputs that baseband signal to first communications network segment 310. In one embodiment, the baseband communications signal is an analog signal. In one embodiment, the baseband communications signal is a digital signal.

As discussed with respect to optical receiver 130, optical laser transceivers 320 and 330 both must receive optical signals within a specific window of optical power to correctly demodulate the optical signals and prevent damage. To ensure that neither transceiver 320 nor transceiver 330 are damaged by high power optical signals and to regulate the power of the optical signals, optical power attenuator 350 attenuates the optical power level of modulated laser light traveling in both directions of fiber optic media 325.

In one embodiment, optical laser transceivers 320 and 330 are each output one or more digital signals representing one or both of the optical power level of the optical signal received and the optical power level of the optical signal being launched. Controller 360 receives the one or more optical power level signals from optical laser transceivers 320 and 330 and generates an attenuation control signal for transmission to optical power attenuator 350 based on one or more of the launch optical power level of transceiver 320, the launch optical power level of optical laser transceiver 330, the received optical power level of optical laser transceiver 320, and the received optical power level of optical laser transceiver 330. Optical power attenuator 350 adjusts the attenuation of the optical signals based on the attenuation control signal.

In one embodiment, controller 360 is adapted to optimally control the attenuation of the optical signals in order to maintain optical power level in both the uplink and downlink directions within the windows of operation for optical laser transceivers 320 and 330. In one embodiment, controller 360 controls the attenuation of optical power attenuator 350 based on an algorithm executed by controller 360.

In one embodiment, where there are balanced links between the uplink and downlink directions, controller 360 controls the attenuation of optical power attenuator 350 based on a weighed average of the two optical power level signals. In one embodiment, controller 360 maintains the optical power level of signals received by optical laser transceivers 320 and 330 within upper and lower reference set points. When the one or more digital signals representing optical power level are greater than an upper reference set point, controller 360 will generate an attenuation control signal that causes optical power attenuator 350 to increase the attenuation of the optical signals in both the uplink and downlink directions. When the one or more digital signals representing optical power level are less than the lower reference set point, controller 360 will generate an attenuation control signal which causes optical power attenuator 350 to reduce the attenuation of the optical signal in both uplink and downlink directions. When the one or more digital signals representing optical power level are within the upper and lower reference set points, controller 360 will generate an attenuation control signal which causes optical power attenuator 350 to maintain attenuation of the optical signal at the current attenuation level.

In one embodiment, controller 360 maintains the optical power level of the signals in the uplink and downlink direction at a specific power level within the window of operation. In one embodiment, controller 360 implements different feedback transfer functions and algorithms to achieve a desired closed loop optical power level response for parameters such as time response, signal dampening, and allowable study state error.

In one embodiment, the attenuation control signal output of controller 360 is a digital signal directly coupled to optical power attenuator 350. In one embodiment, the attenuation control signal output of controller 360 is converted into an analog control signal (Vc) by D/A converter 380 that is coupled to optical power attenuator 350. In one embodiment, analog control signal Vc is a voltage signal. In one embodiment, controller 330 is further adapted to measure Vc and adjust the digital attenuation control signal input to D/A converter 380 to ensure optical power attenuator 350 is receiving the desired feedback signal.

In one embodiment, network 300 further comprises a remote management unit 370 coupled to controller 360 through one or more networks 372. Remote management unit 370 provides an interface that allows a network 300 operator to initialize and configure controller 360. In one embodiment, communication link 372 comprises a network adapted to communicate messages between remote management unit 370 and controller 360. In one embodiment, communication link 372 is a serial communications line. In one embodiment, communication link 372 is an IP based network. In one embodiment, communication link 372 is a wireless link. Remote management unit 370 allows an operator of network 300 to alter reference set points or replace algorithms in controller 360, to interrogate controller 360 to review current set points and algorithms, and to observe the optical power level of optical signals. In one embodiment, controller 360 alerts network operators of anomalies by communicating one or more alarms when optical power levels fall outside a desired operating range. In one embodiment, controller 360 communicates with management module 370 via one or more of, but not limited to, Transaction Language 1 (TL1) network management protocol, Common Management Interface Protocol (CMIP) network management protocol, and simple network management protocol (SNMP) and sending and receiving ASCII based messages through a command line interface.

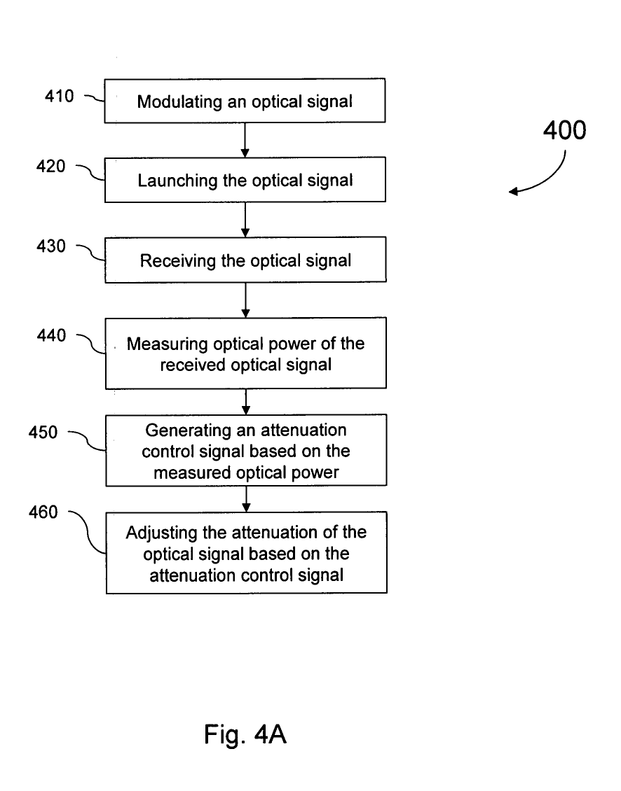

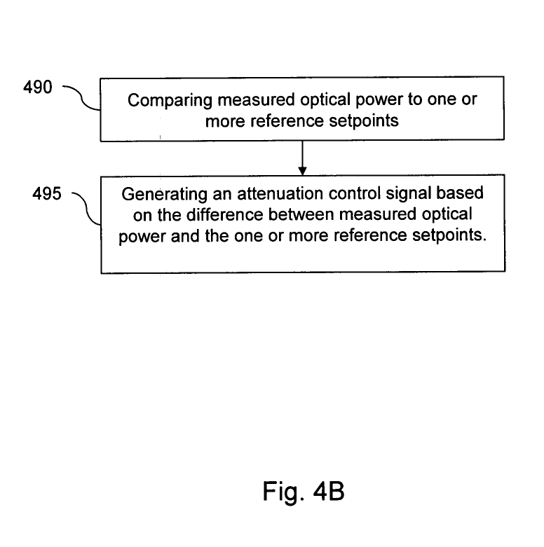

In addition to managing the optical power level of optical signals in a telecommunications network, embodiments of the present invention enable these networks to be self-calibrating with respect to optical power levels. Such networks are self-calibrating because, through embodiments of the present invention, they automatically set optical power levels within each optical receiver's window of operation without the need for human interaction. The self-calibrating characteristics of embodiments of the present invention are illustrated by FIG. 4A.

FIG. 4A is a flow chart illustrating a method 400 for automatically calibrating optical power levels in an optical communications network of one embodiment of the present invention. Method 400 begins at 410 and comprises modulating optical signals with one or more radio frequency communication signals received from a first communications network segment. In one embodiment, the first communications network segment comprises one or more remote units that receive wireless radio frequency communications signals from mobile subscriber units and modulate the signals to a baseband frequency. In one embodiment, the one or more remote units convert the signals from analog into to digitized radio frequency communication signals. The method proceeds to 420 and launches (i.e. transmits) the optical signal on one or more optical media. In one embodiment, the one or more optical media include fiber optic cables. The optical media in one or more of single wavelength, multiple wavelengths and bidirectional wavelength. The method proceeds to 430 and comprises receiving the optical signal. As previously discussed, optical receivers have very specific windows of operation with regards to the optical power of optical signals they receive. When the optical power of the optical signal is above the upper limit of the window, the optical receiver will be damaged. When the optical power of the optical signal is below the lower limit of the window, the optical receiver will be unable to demodulate data carried by the optical signal. The method proceeds to 440 and measures the optical power of the optical signal received by the optical receiver. When the measured optical power is higher than desired (e.g. near or above the upper power limit of the window of operation), then attenuation of the optical light signal needs to be increased. When the measured optical power is lower than desired (e.g. near or above the lower power limit of the window of operation), then the attenuation of the optical light signal needs to be decreased. When the measured optical power is satisfactory (e.g. between the upper and lower limit of the window of operation, or at a specified set point), then the attenuation of the optical should be maintained at the current level. The method proceeds to 450 and generates an attenuation control signal based on the measured optical power. The attenuation of the optical signal is then adjusted based on the attenuation control signal (460).

In one embodiment, the attenuation control signal is an error signal indicating the difference between the measured power level and a desired optical power level. In one embodiment, method 400 determines how to adjust the attenuation of the optical signal by comparing the measured optical power level to one or more reference set points (490) and then generating the attenuation control signal based on the difference between the optical power level and the one or more reference set points (495), as illustrated in FIG. 4B.

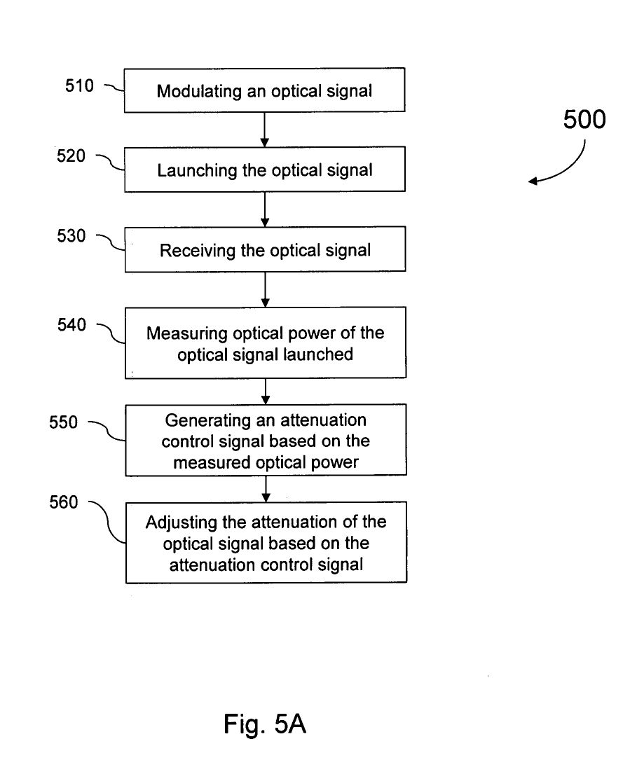

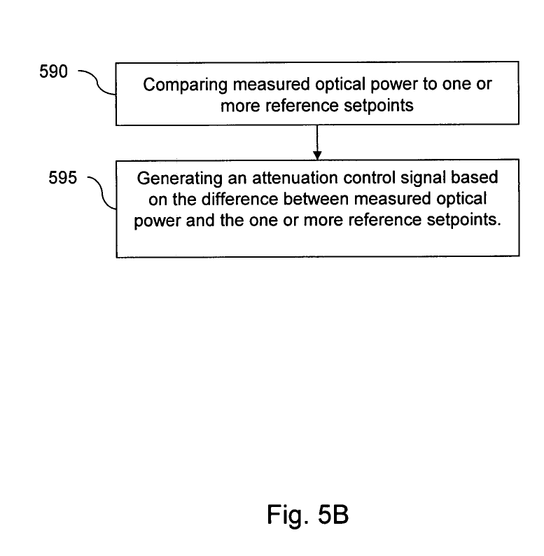

FIG. 5A is a flow chart illustrating a method 500 for automatically calibrating optical power levels in an optical communications network of one embodiment of the present invention. Method 500 begins at 510 and comprises modulating optical signals with one or more radio frequency communication signals received from a first communications network segment. In one embodiment, the first communications network segment comprises one or more remote units that receive wireless radio frequency communications signals from mobile subscriber units and modulate the signals to a baseband frequency. In one embodiment, the one or more remote units further convert the signals from analog into to digitized radio frequency communication signals. The method proceeds to 520 and launches (i.e. transmits) the optical signal on one or more optical media. In one embodiment, the one or more optical media include fiber optic cables. The optical media is one or more of single wavelength, multiple wavelengths and bidirectional wavelength. The method proceeds to 530 and comprises receiving the optical signal.

As opposed to measuring the optic power of the optical signal when it is received, as in method 400, method 500 proceeds to 540 and measures the optical power of the optical signal when it is launched. When the measured optical power is higher than desired (e.g. a launched optical power level that will result in a received optical power level near or above the upper power limit of the window of operation), then attenuation of the optical light signal needs to be increased. When the measured optical power is lower than desired (e.g. a launched optical power level that will result in a received optical power level near or above the lower power limit of the window of operation), then the attenuation of the optical light signal needs to be decreased. When the measured optical power is satisfactory (e.g. a launched optical power level that will result in a received optical power level between the upper and lower limit of the window of operation, or at a specified set point), then the attenuation of the optical should be maintained at the current level. The method proceeds to 550 and generates an attenuation control signal based on the measured optical power. The attenuation of the optical signal is then adjusted based on the attenuation control signal (560).

In one embodiment, the attenuation control signal is an error signal indicating the difference between the measured power level and a desired optical power level. In one embodiment, method 500 determines how to adjust the attenuation of the optical signal by comparing the measured optical power level to one or more reference set points (590) and then generating the attenuation control signal based on the difference between the optical power level and the one or more reference set points (595), as illustrated in FIG. 5B.

In one embodiment, in a communications network such as networks 100, 200 and 300, the optical power attenuator defaults to maximum attenuation of optical power upon a loss of the attenuation control signal output from a controller in order to prevent damage to an optical receiver in the event of a failure of a component in the feedback system.

Although the examples of embodiments in this specification are described in terms of the communications networks comprising a single inline attenuator, embodiments of the present invention are not limited to such applications. Embodiments of the present invention are just as applicable to communications networks having two or more attenuators placed in series between an optical transmitter and receiver. Two or more attenuators in series may be useful in applications where more attenuation is required than a single optical power attenuator can provide. In such embodiment one or more of the series optical power attenuators are coupled to a controller of the present invention and adjusted via an attenuation control signal from the controller as described above.

Several means are available to implement the controller of the current invention. These means include, but are not limited to, digital computer systems, programmable controllers, or field programmable gate arrays. Therefore other embodiments of the present invention include program instructions resident on computer readable media that when implemented by such controllers, enable the controllers to implement embodiments of the present invention. Computer readable media include any form of computer memory, including but not limited to punch cards, magnetic disk or tape, any optical data storage system, flash read only memory (ROM), non-volatile ROM, programmable ROM (PROM), erasable-programmable ROM (E-PROM), random access memory (RAM), or any other form of permanent, semi-permanent, or temporary memory storage system or device. Program instructions include, but are not limited to computer-executable instructions executed by computer system processors and hardware description languages such as Very High Speed Integrated Circuit (VHSIC) Hardware Description Language (VHDL).

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. An optical communication network, the network comprising:
a transmitter coupled to a first communications network segment, the transmitter adapted to modulate an optical light signal based on one or more first radio frequency communication signals received from the first communications network and launch the modulated optical light signal;
a receiver coupled to a second communications network, the receiver adapted to receive the modular optical light signal, demodulate the modulated optical light signal into one or more second radio frequency communications signals, and output the one or more second radio frequency communications signals to the second communications network; and
at least one optical power attenuator that dynamically adjusts the attenuation of the modulated optical light signal based on one or more of an optical power level of the received modulated optical light signal and an optical power level of the launched modulated optical light signal.

2. The network of claim 1 further comprising:
a controller coupled to the at least one optical power attenuator, wherein the optical power attenuator attenuates the modulated optical light signal based on an attenuation control signal generated by the controller;
wherein the controller receives one or more power level signals from one or more of the transmitter and the receiver, and generates the attenuation control signal based on the one or more power level signals.

3. The network of claim 2, wherein the receiver outputs a power level signal representing the optical power level of the received optical light signal.

4. The network of claim 2, wherein the transmitter outputs a power level signal representing the optical power level of the launched optical light signal.

5. The network of claim 2, wherein the controller outputs a digital attenuation control signal.

6. The network of claim 5 further comprising:
a digital to analog converter that converts the digital attenuation control signal into an analog signal;
wherein the at least one optical power attenuator inputs the analog signal; and
wherein the at least one optical power attenuator attenuates the modulated optical light signal based on the analog signal.

7. The network of claim 6, wherein the controller monitors the analog signal and adjusts the digital attenuation control signal to obtain a desired attenuation.

8. The network of claim 2, wherein the controller increases the attenuation by the optical power attenuator to reduce the optical power level of the received modulated optical light signal; and
wherein the controller decreases the attenuation by the optical power attenuator to increase the optical power level of the received modulated optical light signal.

9. The network of claim 8, wherein the controller increases and decreases the attenuation by the optical power attenuator based on calculations by a control algorithm executed by the controller.

10. The network of claim 9 further comprising:
a management unit coupled to the controller, wherein the management unit communicates with the controller, receives reconfiguration messages from the management unit, and alters one or more of reference set points and control algorithms based on the reconfiguration messages;
wherein the controller further receives query messages from the management unit and communicates to the management unit the current optical power levels.

11. The network of claim 10, wherein the controller communicates one or more alarms to the management unit when optical power levels fall outside a desired operating range.

12. The network of claim 10, wherein the management unit and controller communicate together by sending and receiving messages with one or more of the Transaction Language 1 network management protocol, the Common Management Interface Protocol, the Common Management Interface, the simple network management protocol, and ASCII based messages through a command line interface.

13. The network of claim 2 further comprising:
a second transmitter coupled to the second communications network segment, the second transmitter adapted to modulate a second optical light signal based on one or more third radio frequency communication signals received from the second communications network, and launch the modulated second optical light signal;
a second receiver coupled to the first communications network, the second receiver adapted to receive the second modulated optical light signal, demodulate the second modulated optical light signal into one or more fourth radio frequency communications signals, and output the one or more fourth radio frequency communications signals to the first communications network; and
wherein the at least one optical power attenuator dynamically adjusts the attenuation of the second modulated optical light signal based on the attenuation control signal.

14. The network of claim 13, wherein
wherein the controller receives one or more second power level signals from one or more of the second transmitter and the second receiver; and
wherein the controller generates the attenuation control signal further based on the one or more second power level signals.

15. A feedback system for controlling optical power levels, the system comprising:
an optical receiver that receives a modulated optical light signal, demodulates the modulated optical light signal into one or more communications signals, and outputs the one or more communications signals to a communications network;
wherein the optical receiver further outputs a digital power level signal representing the optical power level of the received optical light signal;
a controller coupled to the optical receiver, wherein the controller receives the digital power level signal from the optical receiver and outputs an attenuation control signal based on the digital optical power level signal; and
at least one optical power attenuator that dynamically adjusts the attenuation of the modulated optical light signal based on the attenuation control signal.

16. The system of claim 15, wherein when the attenuation control signal is a digital signal, the network further comprises:
a digital to analog converter that converts the digital attenuation control signal into an analog signal;
wherein the at least one optical power attenuator inputs the analog signal; and
wherein the at least one optical power attenuator attenuates the modulated optical light signal based on the analog signal.

17. The system of claim 16, wherein the controller monitors the analog signal and adjusts the digital attenuation control signal to obtain a desired attenuation.

18. The system of claim 15, wherein the controller increases attenuation by the optical power attenuator to reduce the optical power level of the received modulated optical light signal; and
wherein the controller decreases attenuation by the optical power attenuator to increase the optical power level of the received modulated optical light signal.

19. The system of claim 18, wherein the controller increase and decrease attenuation by the optical power attenuator based on calculations by a control algorithm executed by the controller.

20. The system of claim 19 further comprising:
a management unit coupled to the controller, wherein the management unit communicates with the controller, receives reconfiguration messages from the management unit and alters one or more of reference set points and control algorithms based on the reconfiguration messages; and
wherein the controller further receives query messages from the management unit and communicates to the management unit the current optical power level of the received modulated optical light signal.

21. The system of claim 20, wherein the controller communicates one or more alarms to the management unit when optical power levels fall outside a desired operating range.

22. The system of claim 20, wherein the management unit and controller communicate together by sending and receiving messages with one or more of the Transaction Language 1 network management protocol, the Common Management Interface Protocol, the Common Management Interface, the simple network management protocol, and ASCII based messages through a command line interface.

23. A feedback system for controlling optical power levels in a communications network, the system comprising:
an optical transmitter that modulates an optical light signal based on one or more radio frequency communication signals received from a first communications network, launches the optical light signals, and outputs a digital power level signal representing the optical power level of the launched modulated optical light signal;
a controller coupled to the optical transmitter that receives the digital power level signal and outputs an attenuation control signal based on the digital power level signal; and
at least one optical power attenuator that dynamically adjusts the attenuation of the modulated optical light signal based on the attenuation control signal.

24. The system of claim 23, wherein when the attenuation control signal is a digital signal, the circuit further comprises:
a digital to analog converter that converts the digital attenuation control signal into an analog signal;
wherein the at least one optical power attenuator inputs the analog signal; and
wherein the at least one optical power attenuator attenuates the modulated optical light signal based on the analog signal.

25. The system of claim 24, wherein the controller monitors the analog signal and adjusts the digital attenuation control signal to obtain a desired attenuation.

26. The system of claim 23, wherein the controller increases attenuation by the optical power attenuator to reduce the optical power level of the modulated optical light signal; and
wherein the controller decreases attenuation by the optical power attenuator to increase the optical power level of the modulated optical light signal.

27. The system of claim 26, wherein the controller increase and decrease attenuation by the optical power attenuator based on calculations by a control algorithm executed by the controller.

28. The system of claim 27 further comprising:
a management unit coupled to the controller, wherein the management unit communicates with the controller, receives reconfiguration messages from the management unit and alters one or more of reference set points and control algorithms based on the reconfiguration messages; and
wherein the controller receives query messages from the management unit and communicates to the management unit the current optical power level of the modulated optical light signal.

29. The system of claim 28, wherein the controller communicates one or more alarms to the management unit when optical power levels fall outside a desired operating range.

30. The system of claim 28, wherein the management unit and controller communicate together by sending and receiving messages with one or more of the Transaction Language 1 network management protocol, the Common Management Interface Protocol, the Common Management Interface, the simple network management protocol, and ASCII based messages through a command line interface.

31. An apparatus for controlling optical power levels in a communications network, the apparatus comprising:
a controller coupled to an optical receiver, wherein the receiver receives a modulated optical light signal, demodulates the modulated optical light signal into one or more communications signals, and outputs the one or more communications signals;
wherein the optical receiver further outputs a digital power level signal representing the optical power level of the modulated optical light signal; and
wherein the controller receives the digital power level signal and outputs an attenuation control signal based on the digital power level signal.

32. The apparatus of claim 31, wherein the controller further receives reconfiguration messages from a management unit and alters one or more of reference set points and control algorithms based on the reconfiguration messages; and
wherein the controller further receives query messages from the management unit and communicates to the management unit a current optical power level of the modulated optical light signal.

33. The apparatus of claim 32, wherein the controller communicates one or more alarms to the management unit when optical power levels fall outside a desired operating range.

34. A apparatus for controlling optical power levels in a communications network, the apparatus comprising:
a controller coupled to an optical transmitter, wherein the optical transmitter modulates an optical light signal based on one or more radio frequency communication signals received from a first communications network, and launches the modulated optical light signals;
wherein the optical transmitter further outputs a digital optical power level signal representing the optical power level of the modulated optical light signal; and
wherein the controller receives the digital optical power level signal and outputs an attenuation control signal based on the digital power level signal.

35. The apparatus of claim 34, wherein the controller further receives reconfiguration messages from a management unit and alters one or more of reference set points and control algorithms based on the reconfiguration messages; and
wherein the controller further receives query messages from the management unit and communicates to the management unit a current optical power level of the modulated optical light signal.

36. The apparatus of claim 35, wherein the controller communicates one or more alarms to the management unit when optical power levels fall outside a desired operating range.

37. A method for controlling optical power in an optical communications network, the method comprising:
modulating optical signals with one or more radio frequency communication signals received from a first communications network segment;
launching the modulated optical signal on one or more optical media;
receiving the modulated optical signal at an optical receiver;
measuring optical power of one or more of a received optical power level of the modulated optical light and a launched optical power level of the modulated optical light signal;
generating an attenuation control signal based on the measured optical power; and
attenuating the modulated optical signal based on the attenuation control signal.

38. The method of claim 37, wherein generating an attenuation control signal further comprises:
comparing the measured optical power to one or more reference set points; and
generating the attenuation control signal based on the difference between the measured optical power and the one or more reference set points.

39. A method for managing optical power levels in an optical communications network, the method comprising:
receiving an optical signal;
measuring an optical power level of the optical signal;
comparing the measured optical power level to one or more reference set points;
transmitting a feedback signal based on the difference between the measured optical power level and the one or more reference set points; and
attenuating the optical signal based on the feedback signal.

40. A computer-readable medium having computer-executable program instructions for a method for managing optical power levels in an optical communications network, the method comprising:
comparing a measured optical power level of an optical signal to one or more reference set points; and
transmitting a feedback signal based on the difference between the measured optical power level and the one or more reference set points.

41. The method of claim 40 further comprising:
adjusting attenuation of the optical power level of the optical signal based on calculations by an algorithm.

42. The method of claim 41 further comprising:
receiving reconfiguration messages from a management unit; and
altering one or more of reference set points and control algorithms based on the reconfiguration messages.

43. The method of claim 42 further comprising:
receiving query messages from the management unit; and
communicating the measured optical power level to the management unit.

44. The method of claim 43, further comprising:
communicating one or more alarms when optical power levels fall outside a desired operating range.

45. A system for controlling optical power levels in a communications network, the system comprising:
means for demodulating one or more radio frequency communications signals from an modulated optical signal, wherein the means for demodulating measures an optical power level of the modulated optical signal;
means for comparing the measured optical power level to one or more reference set points;
means for transmitting a feedback signal based on the difference between the measured optical power level and the one or more reference set points; and
means for attenuating the modulated optical signal based on the feedback signal.

46. A system for controlling optical power levels in a communications network, the system comprising:
means for modulating an optical signal with one or more radio frequency signals, wherein the means for modulating measures an optical power level of the modulated optical signal;
means for comparing the measured optical power level to one or more reference set points;
means for transmitting a feedback signal based on the difference between the measured optical power level and the one or more reference set points; and
means for attenuating the modulated optical signal based on the feedback signal.
